(19) United States
(12) Patent Application Publication
(10) Pub. No.: US 2003/0078981 A1
(43) Pub. Date: Apr. 24, 2003

(54) System for and method of populating a contact list on a portable device

(75) Inventors: Trevor Harms, Surrey (CA); Tong Shen, Burnaby (CA)

Correspondence Address: FOLEY & LARDNER, 777 EAST WISCONSIN AVENUE, SUITE 3800, MILWAUKEE, WI, 53202-5308, US

(73) Assignee: Infowave Software, Inc.

(21) Appl. No.: 10/039,955

(22) Filed: Oct. 24, 2001

(51) Int. Cl. G06F 15/16

(52) U.S. Cl. 709/206

(57) ABSTRACT

The system and method herein provide for the populating of a contact list on a portable device. Techniques involved can include monitoring and scanning messages in an email inbox to retrieve display names and simple mail transfer protocol (SMTP) addresses of senders and/or recipients for each email. The system and method can selectively filter information from the emails to populate the contact list with new names and resolve any conflicts with existing names.

### FIELD OF THE INVENTION

The present invention relates generally to portable computer device methods and systems. Further, an exemplary embodiment of the present invention relates to a system for and a method of populating a contact list on a portable device.

### BACKGROUND OF THE INVENTION

Portable devices, such as, wireless application protocol (WAP) phones, personal digital assistants (PDAs), palmtop or handheld computers, two-way wireless text-messaging devices, electronic pagers, and other such electronic devices are typically limited in the amount of display screen real estate. Generally, these devices include a relatively small liquid crystal display (LCD) panel. Such portable devices can, nevertheless, provide access to information, such as, e-mail and documents using an organizational structure involving folders or directories. Unfortunately, portable devices do not have many of the same functionalities as larger, less portable devices.

Due to the limited real estate and entry capabilities of portable devices, populating a contact list on a portable device can be onerous compared to populating a meeting on a networked computer or laptop. Currently, a user has to either manually input a contact into the Contact list, or the user has to have the contact already in their desktop Contact list where it is copied to the portable device in a synchronization process. Manually entering information into a Contacts list is time consuming and inconvenient. Particularly, if a user is away from their desktop for an extended period of time, the user may want to add contacts received by email wirelessly.

Some conventional desk top computer systems have an option to add a contact by right clicking on an email sender name using a mouse input device and selecting an option from a pop up window to add the name to the contact list. One example of such a personal computer conventional system that allows individual email addresses to be saved to a contact list is the OUTLOOK program sold by Microsoft Corporation of Redmond, Wash., U.S.A.. Some web based email applications, such as Hotmail available at the web address http://www.hotmail.com, have the ability to add email addresses from an email to the address book. However, such conventional functionality has not heretofore been available on portable devices. Further, such conventional systems only provide the functionality on a per email basis. The function is not automatic and does not allow for filtering and selectivity. Furthermore, such systems and methods do not have the ability to scan through the entire message store and to resolve name conflicts.

Thus, there is a need for an improved technique for populating a contact list on a portable device. Further, there is a need for automatically and selectively taking personal information from one application to an address book application. Yet even further, there is a need to provide a filtering and conflict solution to methods of populating contact lists.

The teachings hereinbelow extend to those embodiments which fall within the scope of the appended claims, regardless of whether they accomplish one or more of the above-mentioned needs.

### SUMMARY OF THE INVENTION

The present invention relates to a system for and method of populating a contact list on a portable device. Techniques involved can include monitoring and scanning messages in an email inbox to retrieve display names and simple mail transfer protocol (SMTP) addresses of senders and/or recipients for each email. The system and method can selectively filter information from the emails to populate the contact list with new names and resolve any conflicts with existing names.

An exemplary embodiment of the present invention relates to a method of populating a contact list on a portable device. This method can include extracting contact information from a number of messages stored in a memory in the portable device and entering the extracted contact information into a contact list maintained by a program operating on the portable device.

Another exemplary embodiment of the present invention relates to a user interface in a portable device which facilitates the populating of a contact list on a portable device. This user interface can include means for extracting contact information from a number of messages stored in a memory in the portable device, means for presenting the extracted contact information on the portable device, means for receiving a number of selections of contact to be stored in the contact list, and means for entering the selected contact information into a contact list maintained by a program operating on the portable device.

Another exemplary embodiment of the present invention relates to a processing system including a central processing unit (CPU) and a storage device coupled to a processor and having stored there information for configuring the CPU. The CPU can be configured to: extract contact information from a number of messages stored in a memory in the portable device and enter the extracted contact information into a contact list maintained by a program operating on the portable device.

Another exemplary embodiment of the present invention relates to a system for populating a contact list on a portable device entry device. This system can include means for means for extracting contact information from a number of messages stored in a memory in the portable device and means for entering the extracted contact information into a contact list maintained by a program operating on the portable device.

Other features and advantages of embodiments of the present invention will become apparent to those skilled in the art upon review of the following drawings, the detailed description, and the appended claims.

### BRIEF DESCRIPTION OF THE DRAWINGS

The invention is illustrated by way of example and not limitation using the figures of the accompanying drawings, in which like references indicate similar elements and in which:

FIG. 1 is a general block diagram of a limited text entry device communicatively coupled to a network in accordance with an exemplary embodiment;

FIG. 2 is a flow diagram illustrating a method of populating a contact list using a portable device in accordance with an exemplary embodiment;

FIG. 3 is a flow diagram illustrating a method of populating a contact list using a portable device in accordance with another exemplary embodiment;

FIG. 4 is a screen display of a portable device illustrating a contact selection window in accordance with an exemplary embodiment;

FIG. 5 is a screen display of a portable device illustrating a conflict resolution window in accordance with an exemplary embodiment;

FIG. 6 is a screen display of a portable device illustrating a rules selection window in accordance with an exemplary embodiment; and

FIG. 7 is a screen display of a portable device illustrating a conflict resolution window in accordance with an exemplary embodiment.

### DETAILED DESCRIPTION OF THE EXEMPLARY EMBODIMENTS

A system for and method of populating a contact list on a portable device are described herein. In the following description, for purposes of explanation, numerous specific details are set forth to provide a thorough understanding of exemplary embodiments of the invention. It will be evident, however, to one skilled in the art that the invention may be practiced without these specific details. In other instances, structures and devices are shown in diagram form to facilitate description of the exemplary embodiments.

In one embodiment, a computer system is used which has a processing unit or central processing unit (CPU) that executes sequences of instructions contained in a memory. More specifically, execution of the sequences of instructions causes the CPU to perform steps, which are described below. The instructions may be loaded into a random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any specific combination of hardware circuitry and software, nor to any particular source for the instructions executed by the computer system.

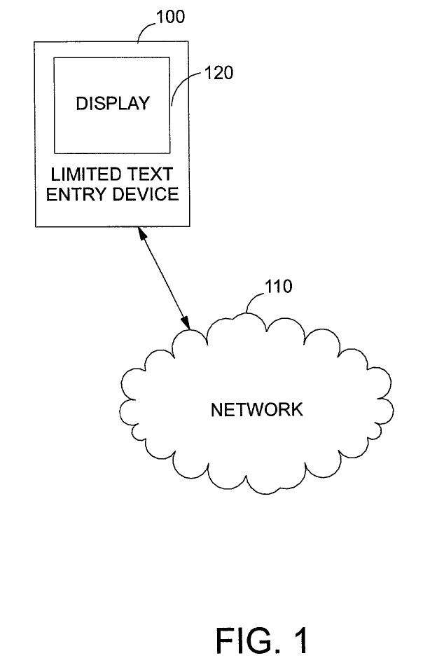

FIG. 1 illustrates a device 100 configured to communicate with a network 110. Device 100 can be a wireless cellular digital phone (e.g., a WAP phone), a handheld personal digital assistant, a two-way text messaging device (e.g., two-way pager), a laptop computer, a handheld computer, or any other such device. In an exemplary embodiment, network 110 is the Internet, a worldwide network of computer networks that use various protocols to facilitate data transmission and exchange. Network 110 can use a protocol, such as, the TCP/IP network protocol or the DECnet, X.25, and UDP protocols. In alternative embodiments, network 110 is any type of network, such as, a virtual private network (VPN), an Internet, an Ethernet, or a Netware network. Further, network 110 can include a configuration, such as, a wireless network, a wide area network (WAN) or a local area network (LAN). Network 110 preferably provides communication with Hypertext Markup Language (HTML) Web pages.

Device 100 includes a display 120 that is configured to present textual and graphical representations. Display 120 can be a monochrome, black and white, or color display and can be configured to allow touch screen capabilities. Display 120 includes a limited real estate space for presenting information. Depending on the type of device 100, display 120 can have a wide variety of different dimensions. By way of example, display 120 is a WAP phone display having twelve horizontal lines of text capability. In alternative embodiments, display 120 can include more or fewer lines of text and graphics capability.

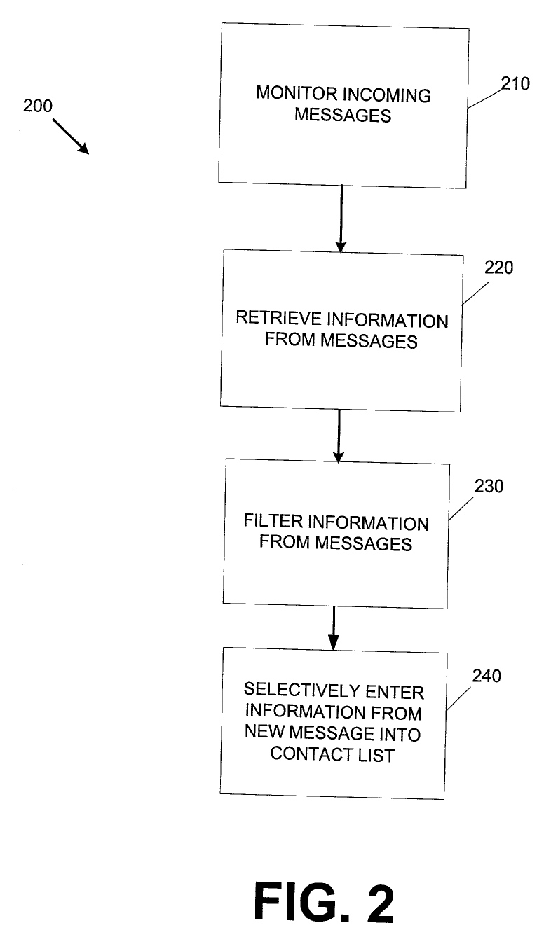

FIG. 2 illustrates a flow diagram 200 of an exemplary method of populating a contact list on a portable device. In a step 210, incoming messages are monitored. In an exemplary embodiment, messages are monitored using a program running in the background of the operating system. In an alternative embodiment, messages are monitored upon a triggering action as commanded by the user. For example, the user can select an option from a menu to scan messages stored in a database.

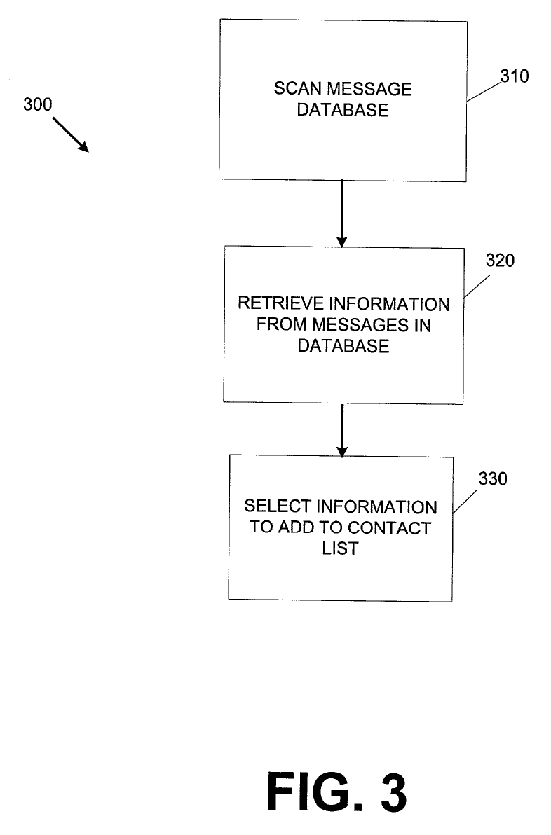

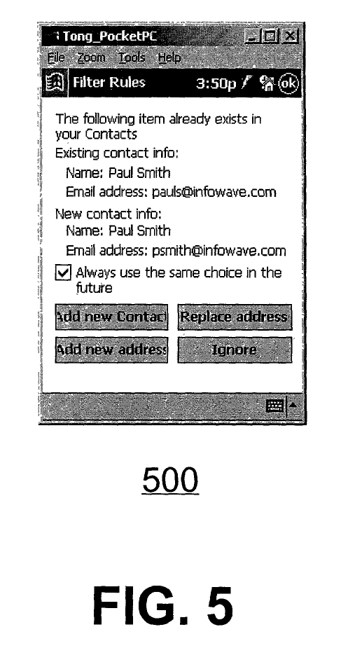

Once an incoming message is received or a monitoring trigger is set, a step 220 is performed in which information is retrieved from the new message or messages in a database. The information retrieved from the messages can include identification information of senders and/or recipients, such as, an email address and/or a name. In a step 230, information from the new message is filtered to remove information that may not be compatible or desirable with the contact list of the portable device. Examples of filtering rules are described with reference to FIGS. 5-7. Such filtering can be user-defined, as discussed with reference to FIG. 3. In an alternative embodiment, steps 220 and 230 are combined such that only information needed for a contact list is retrieved.

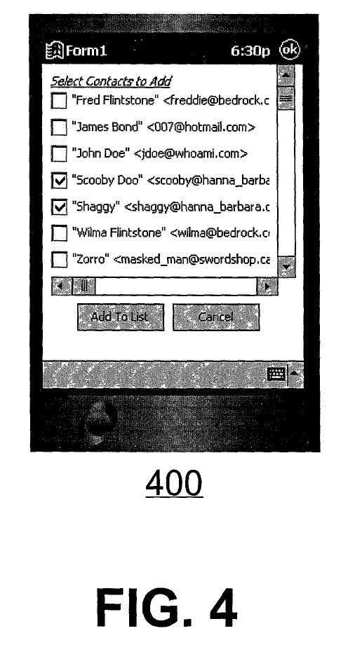

In a step 240, information from the new message can be selectively entered into the contact list. The information selectively entered can be done in a variety of ways. In an exemplary embodiment, the user is presented with a graphical user interface (GUI) listing people and/or email address information found in scanned messages. The user can select which of the individuals to add to the Contact list in a variety of ways, such as, touching a touch display screen at a location or moving a cursor to an individual to be added using some other input device. Example GUIs are described further with reference to FIGS. 4-7.

Advantageously, the method described with reference to FIG. 2 helps to overcome some of the difficulties with entering user contact information on portable devices. It can be important that contact information be located in a Contact list as many programs can require email addresses to be in the Contact list for different features to work. For example, some programs used to compose a meeting request on the POCKET PC operating system sold by Microsoft Corporation of Redmond, Washington, U.S.A. require that people invited to meetings have their email address in the Contact list.

FIG. 3 illustrates a flow diagram 300 of another exemplary method of populating a contact list on a portable device. In a step 310, messages in a database or storage device are scanned or reviewed by a program residing in memory of the portable device. In an exemplary embodiment, messages are scanned as desired by the user of the portable device by inputting some command.

A step 320 is performed in which information from the messages in the database or storage device is retrieved. Information that may be pertinent includes, but is not limited to, a simple mail transfer protocol (SMTP) email address of a message sender or a message recipient other than the owner of the portable device (e.g., in the case of messages with multiple recipients). Other information may also be retrieved.

A step 330 is performed in which information retrieved from the messages can be added to a Contact list stored in a database or memory structure associated with the portable device. The information can be stored automatically or after approval by the user.

By way of example, selective entry of information into a Contact list can be done by receiving input from the user. The user can be prompted with different GUIs where applicable. FIGS. 4-7 illustrate exemplary displays which include user interfaces that can be utilized in an exemplary system or method. As this description provides exemplary embodiments, other user interfaces can also be utilized for a variety of different platforms. For example, different user interfaces can be used with wireless application protocol (WAP) devices, personal digital assistants (PDAs), or any device which can be configured to perform the exemplary functions described herein.

FIG. 4 illustrates a display 400 in which the user can select the contacts that he or she wants to add to the Contact list of the portable device. Using display 400, the user can select by checking a box whether the information should be added to the Contact list. After the user resolves all contacts and selects which contacts it would like to add, the contacts are entered into the Contact list by clicking an OK or Add Contacts button.

FIG. 5 illustrates a display 500 in which the user can select from several options upon the detection of a conflict with information in the Contact list. Using display 500, the user can select to add the information detected as a new Contact, add the information to the existing Contact, replace the information in the existing Contact with the new information, or ignore the new information. As an option, the user can check a box that sets the user's selection as a default selection for use in the future. In alternative embodiments, other selections for conflict resolution may be available and different options may be provided.

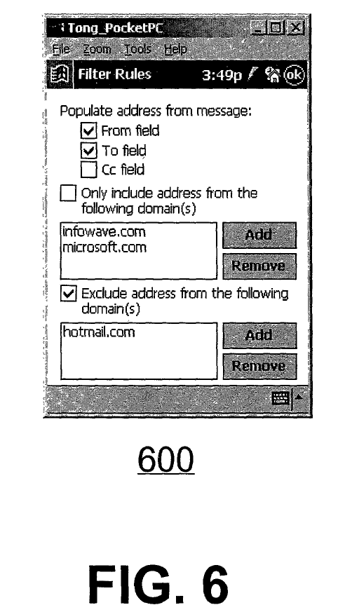

FIG. 6 illustrates a display 600 in which the user can set preferences or rules for a filter to be applied to messages scanned or retrieved in a process of populating a contact list as described with reference to FIGS. 1-3. As an example, using display 600, a user can select a rule to populate address information in the Contact list from the “From field” and the “To Field” of messages. In such an example, address information is retrieved from the sender of the messages and all recipients of the message. Another option allows address information to be gathered from the carbon copy (the “cc”) field. In display 600, the user can set a filter to include messages from one or more specified domains and exclude messages from one or more specified domains. In alternative embodiments, other selections for filtering may be available and different rule-setting options may be provided.

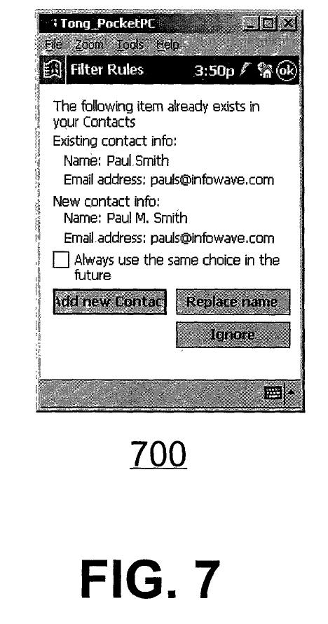

FIG. 7 illustrates a display 700 in which the user can select from several options upon the detection of a conflict with name information in the Contact list. Using display 700, the user can select to add the information detected as a new Contact, replace the name information in the existing Contact with the new name information, or ignore the new information. As an option, the user can check a box that sets the user's selection as a default selection for use in the future. In alternative embodiments, other selections for conflict resolution may be available and different options may be provided.

In an exemplary embodiment, the user can choose the information to keep when there is a conflict. For example, rather than displaying every single contact found in a scan of a database or of the Inbox, the user can be provided those contacts that do not already appear in the Contact list. The user can also be prompted when a conflict occurs where a contact in the list has the same SMTP address but a different display name. The user can choose which display name they want to keep, or to create a new contact. When a contact already in the Contact list has same display name but does not have the SMTP address from the email associated with it, the user can resolve this conflict by either adding that SMTP address to the Contact, or by creating a new contact. The user can remove other SMTP addresses from the contact should they add the new SMTP address.

As discussed with reference to FIG. 6, the user can also define rules for filtering the information to add to the contact list. The rules can include, but are not limited to, the following:

Including or excluding emails from certain domains;

Including or excluding retrieved address from certain domains;

Including only the email sender information or include other recipient information; and

Scanning messages since a certain time stamp, such as since the last scan time, or only scan new messages. The time stamp can be automatically updated on each scan.

In an exemplary embodiment, the method described with reference to the FIGURES is included in a wireless service provider program such that users of a wireless service can more easily populate their contact list.

In alternative embodiments, there are options to limit the choice of contacts from emails back to a certain date. This option prevents someone being provided with option to add a certain contact that the user already decided not to add in a previous execution of the method, unless a newer message has been received.

In another alternative embodiment, all graphical user interfaces (GUIs) are eliminated and the method automatically adds all contacts found in the Inbox to the Contact list that are not already there. Further, a GUI can be provided to handle conflicts or, in the alternative, a unique contact can be assumed for each conflicting entry. For example, if the display name is different or the SMTP address is not found, a new Contact entry is created. In yet another exemplary embodiment, contacts can be added if the SMTP address is not found already in the Contact list.

In a similar fashion, uniform resource locators (URLs) from a History list can be added to a Favorites list. When a user visits a web site using, for example, portable device 100 described with reference to FIG. 1, a method similar to that described with reference to the FIGURES can monitor the URL and add to a Favorites list according to rules defined by the user. In further alternative embodiments, setup rules can be defined to collect image files, music files, and video files from an Internet Temporary folder, to which those files are downloaded when browsing the web.

Advantageously, the system and method of FIGS. 1-7 provides for the populating of a contact list on a portable device, such as, a WAP phone or PDA. Further, the system and method described helps resolves conflicts for multiple instances of a contact in the Contact list using a portable device. The system and method described with reference to the FIGURES also allows a user to add contacts that appear in an Inbox without manually entering them. Such functionality saves the user time and is more convenient. For a user away from his desktop for an extended period of time, the functionality of easily adding contacts is particularly helpful.

Advantageously, if someone sends the user of a portable device an email and it is in the Inbox, the system and method allows the user to correspond with that person later on using the individual's contact information in the Contact list.

While the embodiments illustrated in the FIGURES and described above are presently preferred, it should be understood that these embodiments are offered by way of example only. Other embodiments may include additional procedures or steps not described here. The invention is not limited to a particular embodiment, but extends to various modifications, combinations, and permutations that nevertheless fall within the scope and spirit of the appended claims.

What is claimed is:

1. A method of populating a contact list on a portable device, the method comprising:
extracting contact information from a number of messages stored in a memory in the portable device; and
entering the extracted contact information into a contact list maintained by a program operating on the portable device.

2. The method of claim 1, wherein extracting contact information includes monitoring incoming messages and retrieving contact information from incoming messages.

3. The method of claim 1, wherein contact information includes a simple mail transfer protocol (SMTP) email address.

4. The method of claim 1, wherein extracting contact information includes scanning a message database and retrieving contact information from messages contained in the database.

5. The method of claim 4, wherein the scanning occurs since a certain time.

6. The method of claim 5, wherein the certain time is the time of the last scanning.

7. The method of claim 1, wherein entering the extracted contact information into a contact list maintained by a program operating on the portable device includes providing a graphical user interface (GUI) with contact information configured to receive a selection from a user of the portable device.

8. The method of claim 1, wherein entering the extracted contact information into a contact list maintained by a program operating on the portable device includes automatically entering in the contact list only contact information not already contained in the contact list.

9. The method of claim 1, further comprising filtering contact information to include or exclude from the contact list contact information from emails received from certain domains.

10. The method of claim 1, further comprising filtering contact information to include or exclude from the contact list contact information from retrieved addresses from certain domains.

11. The method of claim 1, further comprising filtering contact information to include in the contact list only email sender information.

12. In a portable device, a user interface configured to facilitate the populating of a contact list, the user interface comprising:
means for extracting contact information from a number of messages stored in a memory in the portable device;
means for presenting the extracted contact information on the portable device;
means for receiving a number of selections of contact to be stored in the contact list; and
means for entering the selected contact information into a contact list maintained by a program operating on the portable device.

13. The user interface of claim 12, wherein means for presenting the extracted contact information on the portable device includes means for providing a checklist of extracted contact information.

14. The user interface of claim 12, wherein means for presenting the extracted contact information on the portable device includes a display on a wireless application protocol (WAP) phone.

15. The user interface of claim 12, wherein means for entering the selected contact information into a contact list maintained by a program operating on the portable device includes means for automatically entering in the contact list only contact information not already contained in the contact list.

16. A processing system comprising:
a central processing unit (CPU); and
a storage device coupled to a processor and having stored there information for configuring the CPU to:
extract contact information from a number of messages stored in a memory in the portable device; and
enter the extracted contact information into a contact list maintained by a program operating on the portable device.

17. The system of claim 16, wherein the CPU is further configured to monitor incoming messages and retrieve contact information from incoming messages.

18. The system of claim 16, wherein the CPU is further configured to scan a message database and retrieve contact information from messages contained in the database.

19. The system of claim 15, wherein the CPU is further configured to provide a graphical user interface (GUI) with contact information configured to receive a selection from a user of the portable device..

20. The system of claim 15, wherein the CPU is further configured to automatically enter into the contact list only contact information not already contained in the contact list.

21. A system for populating a contact list on a portable device, the system comprising:
means for extracting contact information from a number of messages stored in a memory in the portable device; and
means for entering the extracted contact information into a contact list maintained by a program operating on the portable device.
